(19) United States
(12) Patent Application Publication
(10) Pub. No.: US 2025/0263577 A1
(43) Pub. Date: Aug. 21, 2025

(54) PROTECTIVE FILM AND OPTICAL ARTICLE INCLUDING THE SAME

(71) Applicant: Electronics and Telecommunications Research Institute, Daejeon (KR)

(72) Inventors: Woo Seok YANG, Daejeon (KR); Sunghoon HONG, Daejeon (KR)

(73) Assignee: Electronics and Telecommunications Research Institute, Daejeon (KR)

(21) Appl. No.: 18/982,444

(22) Filed: Dec. 16, 2024

(30) Foreign Application Priority Data
Feb. 19, 2024 (KR) 10-2024-0023451
Apr. 5, 2024 (KR) 10-2024-0046976

(51) Int. Cl. C09D 175/02; C09D 7/65

(52) U.S. Cl. CPC C09D 175/02; C09D 7/65

(57) ABSTRACT

Provided are a protective film and an optical article. More particularly, provided is a protective film including a substrate including a first surface and a second surface facing each other, and a first film portion disposed on the first surface, wherein the first film portion includes aliphatic polyurea and polysilazane, and the aliphatic polyurea is a polymer prepared through a urea bond of aliphatic polyisocyanate and aliphatic polyamine.

### CROSS-REFERENCE TO RELATED APPLICATIONS

This U.S. non-provisional patent application claims priority under 35 U.S.C. § 119 of Korean Patent Application Nos. 10-2024-0023451, filed on Feb. 19, 2024, and 10-2024-0046976, filed on Apr. 5, 2024, the entire contents of which are hereby incorporated by reference.

### BACKGROUND

The present disclosure relates to a protective film and an optical article including the same.

Protective films for optical articles are supposed to both protect a display portion of optical articles from external impacts and to deliver clear images. Accordingly, protective films exhibiting excellent impact resistance and scratch resistance are required to enhance the performance and lifespan of optical articles. In addition, the protective films need to be flexible for applications in flexible optical articles such as flexible displays.

Typical protective films for optical articles fail in providing impact resistance, scratch resistance, and flexibility at once. Inorganic materials, while offering excellent scratch resistance, often suffer from poor impact resistance and are prone to cracking during folding. Conversely, organic materials, though flexible and impact-resistant, lack sufficient scratch resistance.

### SUMMARY

The present disclosure provides a protective film for an optical article, providing impact resistance, scratch resistance, and flexibility at once.

An embodiment of the inventive concept provides a protective film including a substrate including a first surface and a second surface facing each other, and a first film portion disposed on the first surface, wherein the first film portion includes aliphatic polyurea and polysilazane, and the aliphatic polyurea is a polymer prepared through a urea bond of aliphatic polyisocyanate and aliphatic polyamine.

In an embodiment, the aliphatic polyurea and the polysilazane may be provided in a weight ratio of about 7:3 to about 9:1.

In an embodiment, the aliphatic polyisocyanate may include a diisocyanate oligomer.

In an embodiment, the aliphatic polyisocyanate may include at least one of a compound of Formula 1 below, a compound of Formula 2 below, or a compound of Formula 3 below.

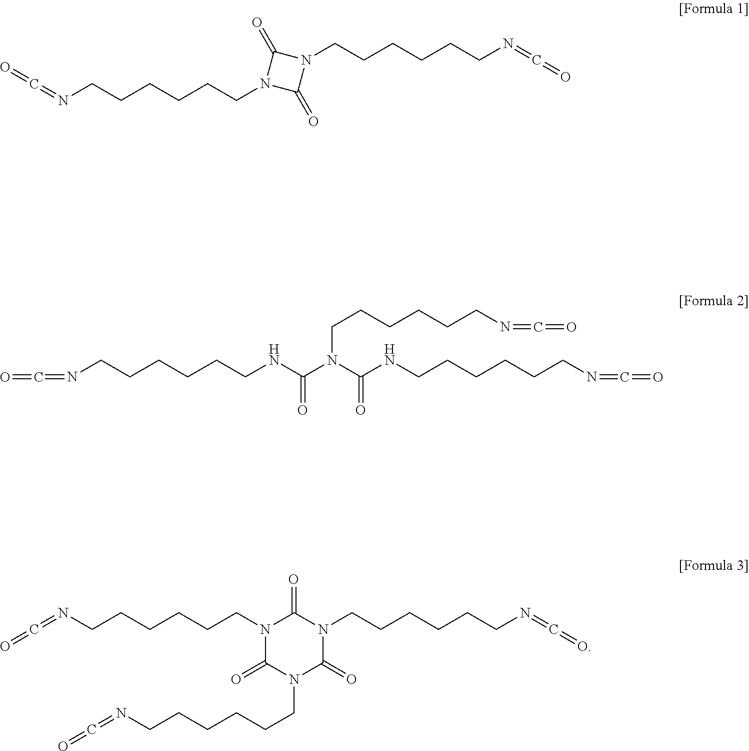 [SMILES: O=C=NCCCCCCN1C(=O)N(CCCCCCN=C=O)C1=O ; O=C=NCCCCCCNC(=O)N(CCCCCCN=C=O)C(=O)NCCCCCCN=C=O ; O=C=NCCCCCCn1c(=O)n(CCCCCCN=C=O)c(=O)n(CCCCCCN=C=O)c1=O]

In an embodiment, the aliphatic polyisocyanate may contain about 16 wt % to about 24 wt % of a —NCO group.

In an embodiment, the aliphatic polyamine may include a polyaspartic ester.

In an embodiment, the aliphatic polyamine may have an amine value of about 180 mg KOH/g to about 210 mg KOH/g.

In an embodiment, the aliphatic polyamine may include a compound of Formula 4 below or a compound of Formula 5 below.

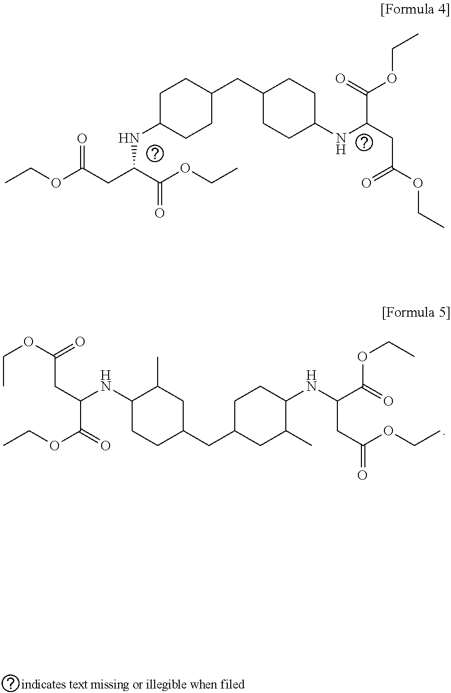

In an embodiment, the aliphatic polyisocyanate and the aliphatic polyamine may be provided in an equivalent ratio of about 0.8:1 to about 1.2:1.

In an embodiment, the polysilazane may be formed through a polymerization reaction of perhydropolysilazane.

In an embodiment, the perhydropolysilazane may be represented by Formula 6 below.

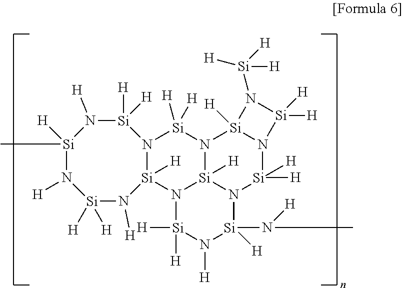

In this case, n ranges from about 9 to about 29.

In an embodiment, the substrate may have a thickness of about 30 μm to about 70 μm.

In an embodiment, the first film portion may have a thickness of about 5 μm to about 40 μm.

In an embodiment, the protective film may further include a first shock absorbing layer positioned between the substrate and the first film portion, and the first shock absorbing layer may include the aliphatic polyurea.

In an embodiment, the first shock absorbing layer may have a thickness of about 30 μm to about 150 μm.

In an embodiment, the protective film may further include a second film portion disposed on the second surface, the second film portion may include aliphatic polyurea and polysilazane, and the aliphatic polyurea may be a polymer prepared through a urea bond of aliphatic polyisocyanate and aliphatic polyamine.

In an embodiment, the protective film may further include a second shock absorbing layer positioned between the substrate and the second film portion, and the second shock absorbing layer may include the aliphatic polyurea.

In an embodiment of the inventive concept, an optical article includes a display portion and a protective film on the display portion, wherein the protective film includes a first surface and a second surface facing each other, and a film portion disposed on at least one of the first surface or the second surface of the substrate, the film portion includes aliphatic polyurea and polysilazane, and the aliphatic polyurea is a polymer prepared through a urea bond of aliphatic polyisocyanate and aliphatic polyamine.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view of a protective film according to some embodiments of the inventive concept;

FIG. 2 is a cross-sectional view of a protective film according to some embodiments of the inventive concept;

FIG. 3 is a cross-sectional view of a protective film according to some embodiments of the inventive concept;

FIG. 4 is a cross-sectional view of a protective film according to some embodiments of the inventive concept;

FIG. 5 is a cross-sectional view of an optical article according to some embodiments of the inventive concept; and

FIGS. 6 to 8 are flowcharts showing a method for preparing a protective film according to some embodiments of the inventive concept.

### DETAILED DESCRIPTION

In order to facilitate sufficient understanding of the configuration and effects of this disclosure, preferred embodiments of the disclosure will be described with reference to the accompanying drawings. However, the disclosure is not limited to the embodiments set forth below, and may be embodied in various forms and modified in many alternate forms. Rather, these embodiments are provided so that this disclosure will be thorough and complete, and will fully convey the scope of the disclosure to those skilled in the art to which the disclosure pertains. In the accompanying drawings, elements are shown enlarged from the actual size thereof for convenience of description, and the ratio of each element may be exaggerated or reduced.

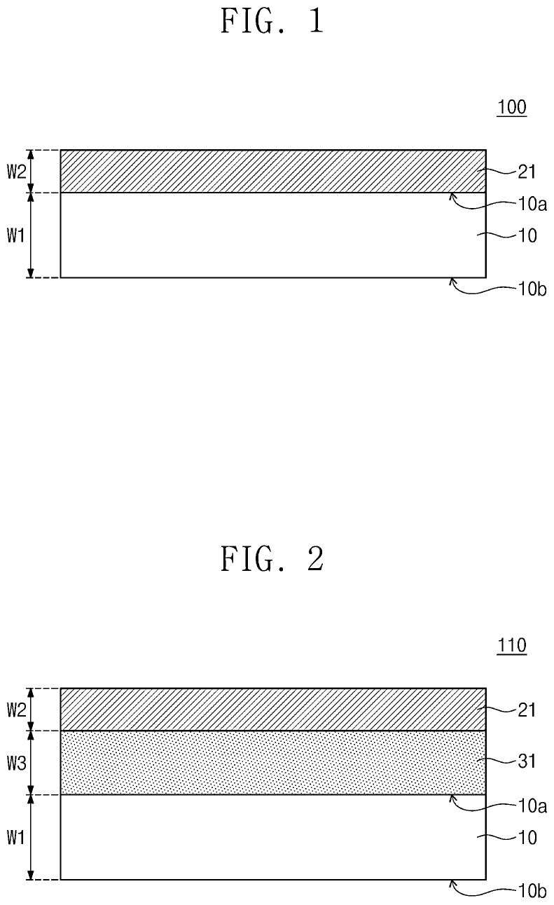

FIGS. 1 to 4 are cross-sectional views showing a protective film according to some embodiments of the inventive concept.

Referring to FIG. 1, a protective film 100 according to some embodiments of the inventive concept may include a substrate 10 and a film portion 21. The film portion 21 may be disposed on the substrate 10. The substrate 10 may include a first surface 10a and a second surface 10b facing each other. The film portion 21 may be disposed on the first surface 10a of the substrate 10.

The substrate 10 may include at least one of a cover window, an optical window, or an optical lens. The substrate 10 may include a polymer, and the polymer may be transparent. The substrate may include at least one of polymethyl methacrylate, polyimide, polyethylene terephthalate, polycarbonate, polystyrene, allyl diglycol carbonate, cyclic olefin copolymer, or polyester. The substrate 10 may have excellent impact resistance. The substrate 10 may have a surface hardness (scratch resistance performance) of 4H or less on the pencil hardness scale. The substrate 10 may have a thickness W1 of about 30 μm to about 70 μm.

When the substrate 10 has a surface hardness of about 2H on the pencil hardness scale, the film portion 21 may have a surface hardness (scratch resistance performance) of at least about 5H on the pencil hardness scale, such as about 5H or about 6H. The film portion 21 may have a visible light transmittance of about 90% or greater.

The film portion 21 may have a thickness W2 of about 5 μm to about 40 μm. The thickness W2 of the film portion 21 may be dependent on the elastic modulus of the substrate 10, and a decrease in the elastic modulus of the substrate 10 may require an increase in the thickness of the film portion 21 to achieve enhanced surface hardness.

The film portion 21 may include polyurea, which is an organic material, and polysilazane, which is an inorganic material. The polyurea may be a polymer prepared through a urea bond between aliphatic polyisocyanate and aliphatic polyamine.

The polyurea and the polysilazane may be provided in a weight ratio of about 7:3 to about 9:1 in the film portion 21. When the polysilazane is provided in an amount of less than about 10 wt % in the film portion 21 with respect to a total weight of the polyurea and the polysilazane, scratch resistance may be reduced. When the polysilazane is provided in an amount of greater than about 30 wt % in the film portion 21 with respect to a total weight of the polyurea and the polysilazane, flexibility and impact resistance may be reduced.

In the film portion 21, the polyurea may be present in a form of a matrix, and the polysilazane may be present in a form dispersed within the polyurea matrix.

The polyurea may be aliphatic, not aromatic. Unlike aromatic polyurea, the aliphatic polyurea may prevent yellowing or whitening caused by UV exposure, and may maintain a high level of visible light transmittance even over long-term use.

In the polyurea, an equivalent ratio of a —NCO group in the polyisocyanate to a —NH group in the polyamine may range from about 0.8:1 to about 1.2:1. The equivalent ratio of the polyisocyanate and the polyamine may range from about 0.8:1 to about 1.2:1. When the equivalent ratio of the polyisocyanate and the polyamine fails to satisfy the numerical range described above, the film portion 21 may have reduced scratch resistance and flexibility.

The —NCO group in the aliphatic polyisocyanate may be provided in an amount of about 16 wt % to about 24 wt %. When the —NCO group in the aliphatic polyisocyanate is provided in an amount less than about 16 wt % or greater than about 24 wt %, scratch resistance and flexibility may be reduced.

The aliphatic polyisocyanate may include a diisocyanate oligomer. The aliphatic polyisocyanate may include at least one of a compound of Formula 1 below (uretdione), a compound of Formula 2 below (biuret), or a compound of Formula 3 below (isocyanurate).

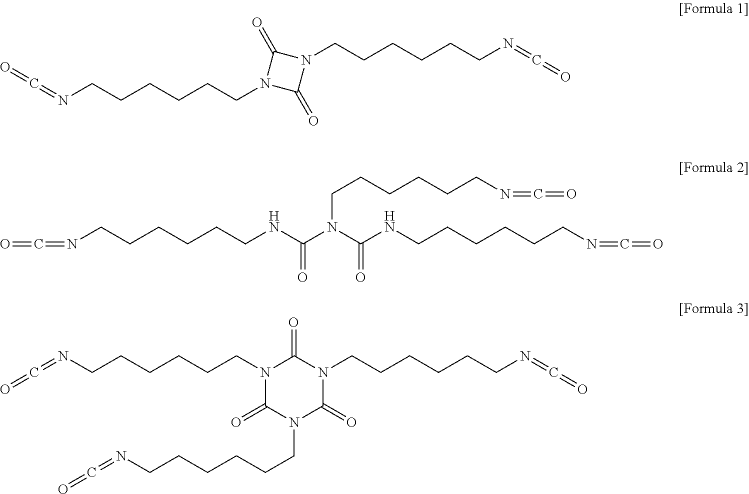

The aliphatic polyamine may include a polyaspartic ester. The aliphatic polyamine may have an amine value of about 180 mg KOH/g to about 210 mg KOH/g. When the amine value of the aliphatic polyamine is less than about 180 mg KOH/g, the reaction rate for urea bond between the polyamine and the polyisocyanate may be too slow, hindering the production of thin, uniform films. When the amine value of the aliphatic polyamine is greater than about 210 mg KOH/g, the reaction rate for urea bond between the polyamine and the polyisocyanate may be too rapid, hindering the production of thin, uniform films.

The aliphatic polyamine may include a compound of Formula 4 below (N,N′-(methylenedi-4,1-cyclohexanediyl)bisaspartic acid tetraethyl ester) or a compound of Formula 5 below (N, N-methylenebis(2-methyl-4,1-cyclohexanediyl)bisaspartic acid tetraethyl ester).

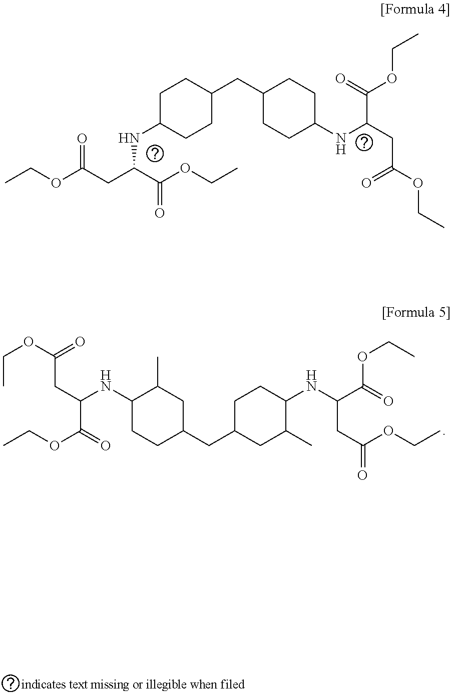

The polysilazane may be an inorganic polysilazane rather than an organic polysilazane. The inorganic polysilazane may be superior to the organic polysilazane in scratch resistance.

The polysilazane may be formed through a polymerization reaction of perhydropolysilazane. The perhydropolysilazane may be represented by Formula 6 below.

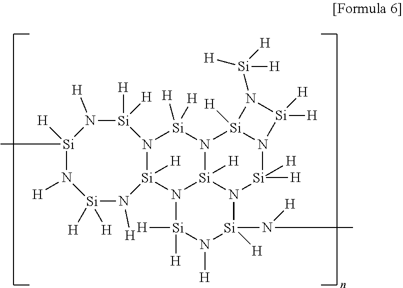

In this case, n ranges from about 9 to about 29.

The perhydropolysilazane may have a weight average molecular weight of about 5,000 to about 15,000. When the average molecular weight of the perhydropolysilazane is less than about 5,000 or greater than about 15,000, cracks or precipitates may form in the preparation of the film portion 21 when mixed with polyurea.

FIG. 2 is a cross-sectional view of a protective film according to some embodiments of the inventive concept. Except for what is described below, detailed descriptions are provided with reference to FIG. 1, and thus further descriptions are not provided here.

Referring to FIG. 2, a protective film 110 according to some embodiments of the inventive concept may further include a shock absorbing layer 31. The shock absorbing layer 31 may be positioned between the substrate 10 and the film portion 21. The shock absorbing layer 31 may be disposed on the first surface 10a of the substrate 10.

The shock absorbing layer 31 may be introduced when the substrate 10 has excellent surface hardness but poor impact resistance. For example, the substrate 10 may have a pencil hardness of about 9H but may be susceptible to impact. The shock absorbing layer 31 may improve the impact resistance of the protective film 100 but may reduce the surface hardness. For example, the shock absorbing layer 31 may increase the impact resistance of the substrate 10 by a factor of about 3 to about 8. For example, when the shock absorbing layer 31 is introduced alone on the substrate 10, the pencil hardness may be about 4H or less. The protective film portion 21 is described in the same way as in FIG. 1.

The shock absorbing layer 31 may have a thickness W3 of about 30 μm to about 150 μm. When the thickness W3 of the shock absorbing layer 31 is less than about 30 μm, impact resistance may be reduced. When the thickness W3 of the shock absorbing layer 31 is greater than about 150 μm, the condition of visible light transmittance of 90% or greater may not be satisfied.

The shock absorbing layer 31 may include polyurea, which is an organic material. The description of the polyurea of the shock absorbing layer 31 is the same as the description of the polyurea of the protective film portion 21.

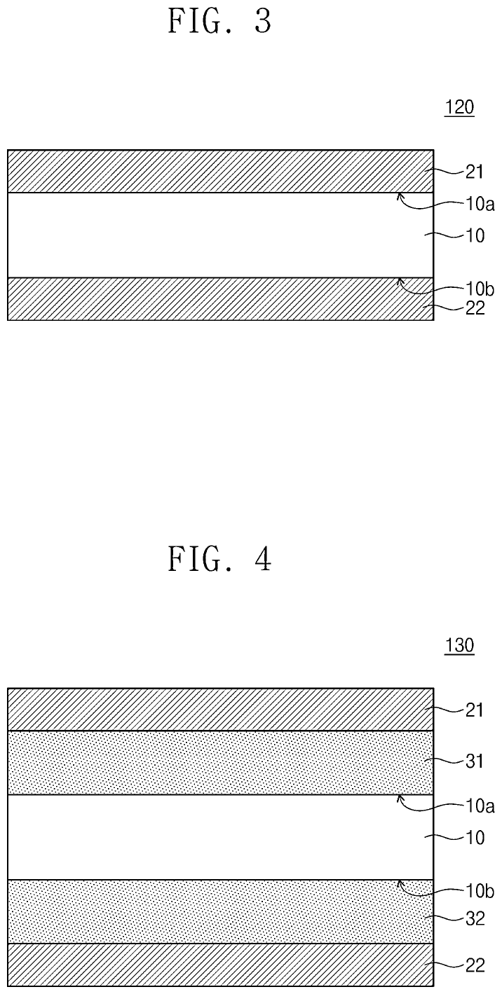

FIG. 3 is a cross-sectional view of a protective film according to some embodiments of the inventive concept. Except for what is described below, detailed descriptions are provided with reference to FIG. 1, and thus further descriptions are not provided here.

Referring to FIG. 3, a protective film 120 according to some embodiments of the inventive concept may further include a second film portion 22. The second film portion 22 may be disposed on the second surface 10b of the substrate 10.

The description of the second film portion 22 is the same as the description of the film portion 21 of FIG. 1. The protective film 100 according to FIG. 3 may have further improved scratch resistance as the film portions 21 and 22 are disposed on both surfaces of the substrate 10.

FIG. 4 is a cross-sectional view of a protective film according to some embodiments of the inventive concept. Except for what is described below, detailed descriptions are provided with reference to FIG. 1, and thus further descriptions are not provided here.

Referring to FIG. 4, a protective film 130 according to some embodiments of the inventive concept may include a substrate 10, a first film portion 21, a second film portion 22, a first shock absorbing layer 31, and a second shock absorbing layer 32. The substrate 10 may include a first surface 10a and a second surface 10b facing each other. The first film portion 21 may be disposed on the first surface 10a of the substrate 10. The second film portion 22 may be disposed on the second surface 10b of the substrate 10.

The first shock absorbing layer 31 may be positioned between the substrate 10 and the first film portion 21. The second shock absorbing layer 32 may be positioned between the substrate 10 and the second film portion 22.

The description of the first shock absorbing layer 31 and the second shock absorbing layer 32 is the same as the description of the shock absorbing layer 31 of FIG. 2. The protective film 100 according to FIG. 4 may have further improved scratch resistance and impact resistance as the film portions 21 and 22 and the shock absorbing layers 31 and 32 are disposed on both surface of the substrate 10.

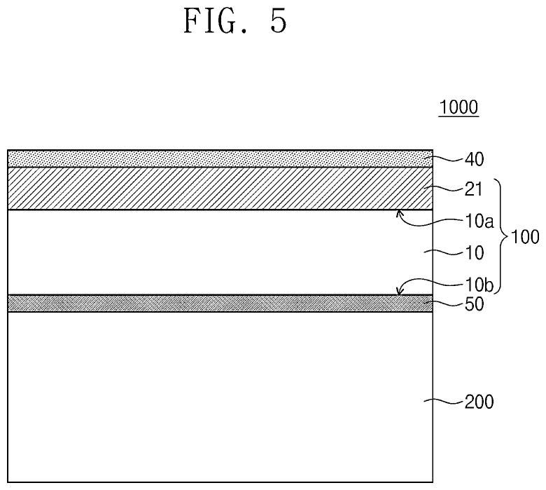

FIG. 5 is a cross-sectional view of an optical article according to some embodiments of the inventive concept.

Referring to FIG. 5, an optical article 1000 according to some embodiments of the inventive concept may include a protective film 100, a display portion 200, an anti-fingerprint layer 40, and a transparent adhesive layer 50. The protective film 100 may be disposed on the display portion 200. The anti-fingerprint layer 40 may be disposed on the film portion 21. The anti-fingerprint layer 40 may be spaced apart from the protective film 100 with the film portion 21 therebetween. The transparent adhesive layer 50 may be disposed on the substrate 10 and may be disposed on the second surface 10b of the substrate 10. The transparent adhesive layer 50 may be positioned between the substrate 10 and the display portion 200.

The description of the substrate 10 is the same as the description of the substrate 10 of FIGS. 1 and 2.

The display portion 200 may include an organic light emitting diode or a micro LED. The display portion 200 may display images. The protective film 100 may cover one surface of the display portion 200. The protective film 100 may improve the scratch resistance and impact resistance of the display portion 200.

The anti-fingerprint layer 40 may reduce fingerprint contamination of the film unit 21. The transparent adhesive layer 50 may adhere the substrate 10 to the display portion 200.

The optical article 1000 may include the protective films 110, 120, and 130) described in FIGS. 2 to 4 instead of the protective film 100 of FIG. 1.

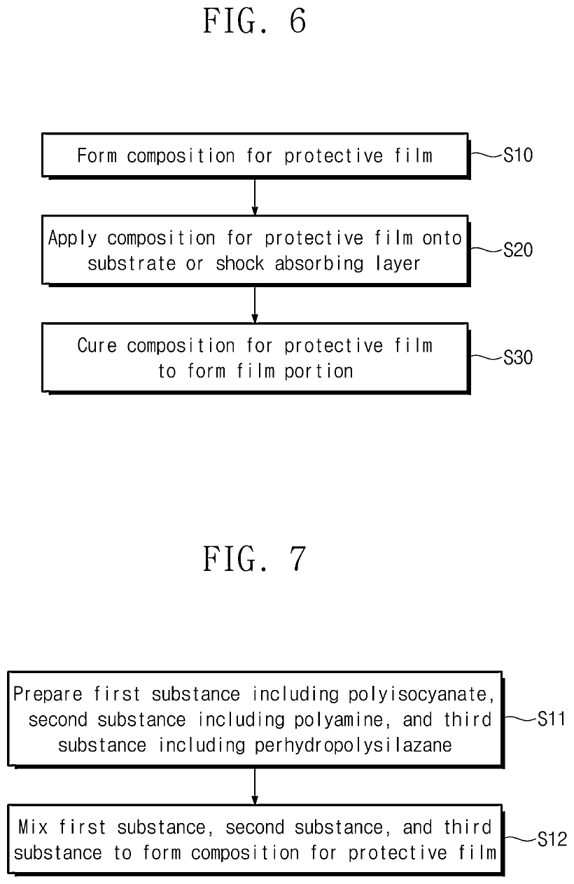

FIGS. 6 to 8 are flowcharts showing a method for preparing a protective film according to some embodiments of the inventive concept.

FIG. 6 is a flowchart showing a method for preparing a film portion 21 according to an embodiment of the inventive concept. FIG. 7 is a flow chart for describing S10 of FIG. 6 in detail.

Referring to FIG. 6, the method for preparing a film portion 21 according to an embodiment of the inventive concept may include forming a composition for a protective film (S10), applying the composition for a protective film onto a substrate 10 or a shock absorbing layer 31 (S20), and curing the composition for a protective film to form a film portion 21 (S30).

Referring to FIG. 7, the forming of a composition for a protective film (S10) may include preparing a first substance including polyisocyanate, a second substance including polyamine, and a third substance including perhydropolysilazane (S11), and mixing the first substance, the second substance, and the third substance to form a composition for a protective film (S12).

The preparing of the first substance including polyisocyanate, the second substance including polyamine, and the third substance including perhydropolysilazane (S11) may include dissolving each of the polyisocyanate, the polyamine, and the perhydropolysilazane in a solvent. The solvent may be dibutyl ether, diisopropyl ether, or methyl tert-butyl ether. The solvent is sufficiently soluble for polyisocyanate, polyamine, and polysilazane, preventing the formation of precipitates.

The mixing of the first substance, the second substance, and the third substance to form a composition for a protective film (S12) may include mixing by adjusting a weight ratio of the first substance and the second substance such that an equivalent ratio of a —NH group in the second substance to a —N═C═O group in the first substance is about 1:0.8 to about 1:1.2. The mixing of the first substance, the second substance, and the third substance to form a composition for a protective film (S12) may include mixing by adjusting a weight ratio of the first substance, the second substance, and the third substance such that the perhydropolysilazane is provided in an amount of about 10 wt % to about 30 wt % with respect to a total weight of solutes, i.e., polyisocyanate, polyamine, and perhydropolysilazane. Subsequently, after the mixing, a composition for a protective film may be formed.

The applying of the composition for a protective film onto the substrate 10 or the shock absorbing layer 31 (S20) may be performed through spin coating or doctor blade coating. When the applying is performed through spin coating or doctor blade coating, the composition for a protective film may be thinly and uniformly applied on the substrate 10.

The curing of the composition for a protective film to form the film portion 21 (S30) may include heat treating the composition for a protective film on the substrate 10. The heat treating may include a first heat treatment process and a second heat treatment process performed after the first heat treatment process. The first heat treatment process may be performed at a pressure of about 0.1 torr to about 760 torr and a temperature of about 40° C. to about 100° C. The second heat treatment process may be performed at a temperature of about 60° C. to about 120° C. in an air atmosphere including water vapor.

The solvent of the composition for a protective film may be dried and removed through the first heat treatment process. A lower boiling point of the solvent in the composition for a protective film and a lower pressure in the first heat treatment process enable more effective drying of the solvent in the composition for a protective film even at low temperatures. The first and second heat treatment processes may induce urea bond between polyisocyanate and polyamine. The second heat treatment process may induce polymerization and oxidation reactions of perhydropolysilazane. A higher humidity level during the second heat treatment process promotes the polymerization and oxidation reactions of perhydropolysilazane even at lower temperatures.

After the first and second heat treatment processes, the film portion 21 may be formed. Lower temperatures in the first and second heat treatment processes result in less volume shrinkage during the formation of the film portion 21, reducing curling or warping of the substrate 10 or the shock absorbing layer 31.

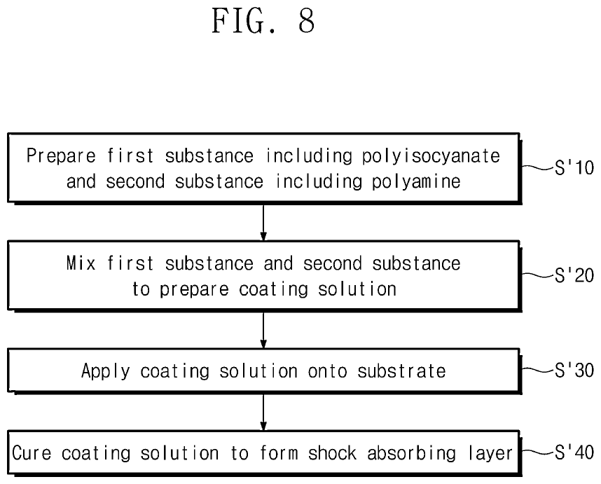

FIG. 8 is a flowchart showing a method for preparing a shock absorbing layer 31 according to an embodiment of the inventive concept. Referring to FIG. 8, the method for preparing a shock absorbing layer 31 according to an embodiment of the inventive concept may include preparing a first substance including polyisocyanate and a second substance including polyamine (S′10), mixing the first substance and the second substance to prepare a coating solution (S′20), applying the coating solution onto a substrate 10 (S′30), and curing the coating solution to form a shock absorbing layer 31 (S′40).

The preparing of the first substance including polyisocyanate and the second substance including polyamine (S′10) may include dissolving each of the polyisocyanate and the polyamine in a solvent. The solvent may be acetone or methyl ethyl ketone. This solvent is highly soluble for polyisocyanate and polyamine, coupled with a high price competitiveness.

The description of the mixing of the first substance and the second substance to prepare a coating solution (S′20) is the same as the description of the mixing of the first substance, the second substance, and the third substance to prepare a coating solution in FIG. 7 (S11). The description of the applying of the coating solution onto the substrate 10 (S′30) is the same as the description of the applying of the coating solution onto the substrate 10 or the shock absorbing layer 31 in FIG. 6 (S20).

The curing of the coating solution to form the shock absorbing layer 31 (S′40) may include performing a heat treatment process on the coating solution. The heat treatment process may be performed at a pressure of about 0.1 torr to about 760 torr and a temperature of about 35° C. to about 80° C.

Embodiments of the disclosure have been described with reference to the accompanying drawings. However, the disclosure may be implemented in other detailed forms without changing the technical spirit or necessary features thereof. It is therefore to be understood that the above-described embodiments are illustrative in all aspects and not restrictive.

What is claimed is:

1. A protective film comprising:
a substrate including a first surface and a second surface facing each other; and
a first film portion disposed on the first surface,
wherein the first film portion includes aliphatic polyurea and polysilazane, and
the aliphatic polyurea is a polymer prepared through a urea bond of aliphatic polyisocyanate and aliphatic polyamine.

2. The protective film of claim 1, wherein the aliphatic polyurea and the polysilazane are provided in a weight ratio of about 7:3 to about 9:1.

3. The protective film of claim 1, wherein the aliphatic polyisocyanate comprises a diisocyanate oligomer.

4. The protective film of claim 1, wherein the aliphatic polyisocyanate comprises at least one of a compound of Formula 1 below, a compound of Formula 2 below, or a compound of Formula 3 below:

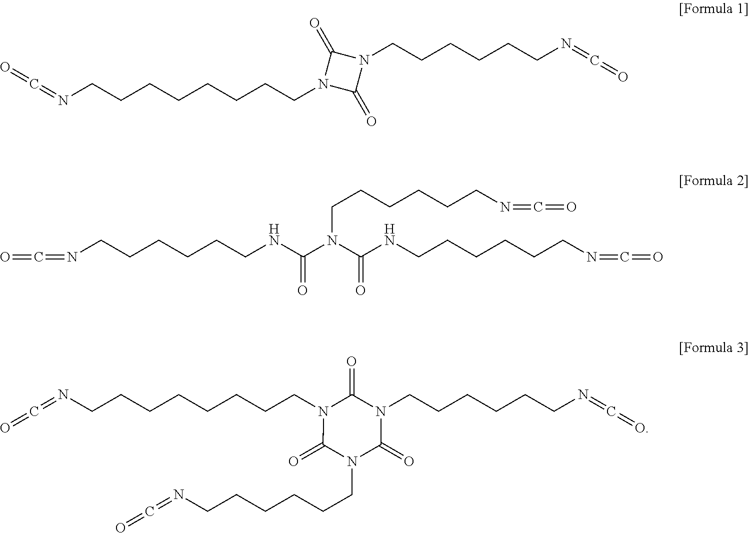 [SMILES: O=C=NCCCCCCCCN1C(=O)N(CCCCCCN=C=O)C1=O ; O=C=NCCCCCCNC(=O)N(CCCCCCN=C=O)C(=O)NCCCCCCN=C=O ; O=C=NCCCCCCCCn1c(=O)n(CCCCCCN=C=O)c(=O)n(CCCCCCN=C=O)c1=O]

5. The protective film of claim 1, wherein the aliphatic polyisocyanate contains about 16 wt % to about 24 wt % of a —NCO group.

6. The protective film of claim 1, wherein the aliphatic polyamine comprises a polyaspartic ester.

7. The protective film of claim 1, wherein the aliphatic polyamine has an amine value of about 180 mg KOH/g to about 210 mg KOH/g.

8. The protective film of claim 1, wherein the aliphatic polyamine comprises a compound of Formula 4 below or a compound of Formula 5 below:

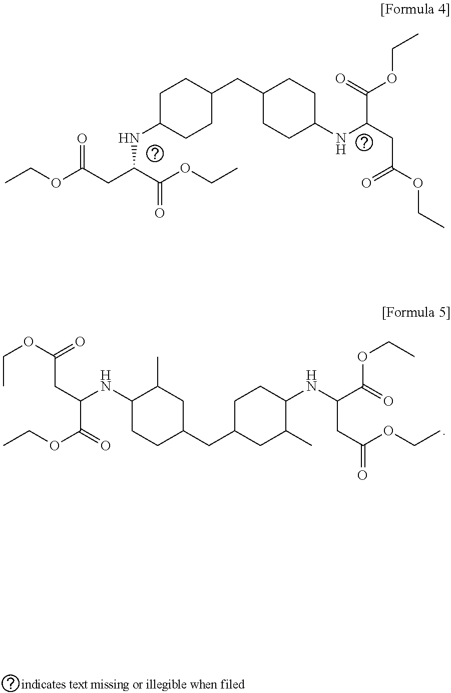

9. The protective film of claim 1, wherein the aliphatic polyisocyanate and the aliphatic polyamine are provided in an equivalent ratio of about 0.8:1 to about 1.2:1.

10. The protective film of claim 1, wherein the polysilazane is formed through a polymerization reaction of perhydropolysilazane.

11. The protective film of claim 10, wherein the perhydropolysilazane is represented by Formula 6 below: 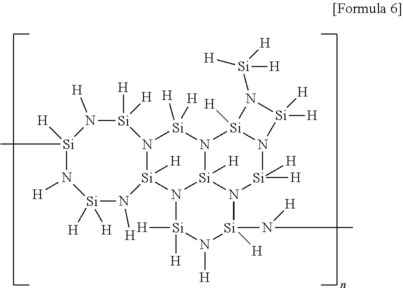
wherein n ranges from about 9 to about 29.

12. The protective film of claim 1, wherein the substrate has a thickness of about 30 μm to about 70 μm.

13. The protective film of claim 1, wherein the first film portion has a thickness of about 5 μm to about 40 μm.

14. The protective film of claim 1, further comprising a first shock absorbing layer positioned between the substrate and the first film portion,
wherein the first shock absorbing layer includes the aliphatic polyurea.

15. The protective film of claim 14, wherein the first shock absorbing layer has a thickness of about 30 μm to about 150 μm.

16. The protective film of claim 1, further comprising a second film portion disposed on the second surface,
wherein the second film portion includes aliphatic polyurea and polysilazane, and
the aliphatic polyurea is a polymer prepared through a urea bond of aliphatic polyisocyanate and aliphatic polyamine.

17. The protective film of claim 16, further comprising a second shock absorbing layer positioned between the substrate and the second film portion,
wherein the second shock absorbing layer includes the aliphatic polyurea.

18. An optical article comprising:
a display portion; and
a protective film on the display portion,
wherein the protective film includes:
a substrate including a first surface and a second surface facing each other; and
a film portion disposed on at least one of the first surface or the second surface of the substrate,
the film portion including aliphatic polyurea and polysilazane,
wherein the aliphatic polyurea is a polymer prepared through a urea bond of aliphatic polyisocyanate and aliphatic polyamine.
